(19) United States
(12) Patent Application Publication
(10) Pub. No.: US 2010/0062399 A1
(43) Pub. Date: Mar. 11, 2010

(54) DISPENSER TIP FILTER ASSEMBLY

(76) Inventor: Adam J. Cernohous, River Falls, WI (US)

Correspondence Address: 3M INNOVATIVE PROPERTIES COMPANY, PO BOX 33427, ST. PAUL, MN, 55133-3427, US

(21) Appl. No.: 12/594,606

(22) PCT Filed: Apr. 21, 2008
(86) PCT No.: PCT/US08/60990

§ 371 Date: Oct. 5, 2009

Related U.S. Application Data
(60) Provisional application No. 60/913,387, filed on Apr. 23, 2007.

(51) Int. Cl. A61C 5/00; B67D 7/76; A61C 5/04

(52) U.S. Cl. 433/226; 222/189.06; 433/215

(57) ABSTRACT

The invention features a dispenser tip filter assembly for dispensing fluid compositions, especially dental compositions, containing solid particles. The assembly includes a dispenser tip comprising a filter housing chamber and an exit orifice, and a filter unit positioned within the filter housing chamber in front of the exit orifice. The filter unit has one or more slots with a width less than the diameter of the exit orifice.

### CROSS-REFERENCE TO RELATED APPLICATIONS

This application claims the benefit of U.S. Patent Application Ser. No. 60/913,387, filed Apr. 23, 2007.

### TECHNICAL FIELD

The invention relates to a filter assembly useful for preventing blockage of a dispenser tip while dispensing a fluid that contains solid particles.

### BACKGROUND

Many chemical compositions are stored in vials, bottles, or similar containers. When the composition is a fluid, it may be dispensed from the container through a dispenser tip that allows for controlled delivery of the composition. Such dispenser tips are particularly useful for dispensing, for example, polymerizable or hardenable compositions, such as adhesives, that are cured after application. Commercially available compositions that are typically dispensed with such tips include SCOTCHBOND MULTIPURPOSE (available from 3M ESPE), and 3M UNITEK GI ORTHODONTIC BRAND CEMENT and TRANSBOND XT PRIMER (available from 3M Unitek).

In some situations, it may be desirable for the composition to contain solid particles or objects, e.g., beads, discs, rods, etc. For example, U.S. provisional patent application No. 60/754,953 describes dental compositions, including dental adhesives, that contain a water scavenger, such as a molecular sieve, within the composition. The molecular sieve may be in the form of, for example, solid beads, which help to keep the composition dry, thereby increasing the stability and shelf-life of the composition. However, the presence of these solid particles within the composition can present difficulties when it is dispensed through a conventional dispenser tip. For example, beads and similar objects can get stuck in the dispensing tip and interfere with the effective dispenser of the composition. In addition, it may be desired that such beads be separated from the composition prior to use and/or remain the vial or other storage container where they can continue to serve their function of increasing shelf-life and stability of the un-used portion of the composition. A need, therefore, exists for a dispensing assembly capable of efficiently and effectively dispensing such compositions from a vial or similar container.

### SUMMARY

The invention features a dispenser tip filter assembly that is useful for dispensing a fluid composition that contains solid particles, such as beads or similar objects. The assembly includes a dispenser tip that has a filter housing chamber that holds a filter unit that filters fluid from the container. The dispenser tip further includes an exit orifice through which the fluid passes on its way out of the tip.

In one embodiment, the filter unit comprises an elongated hollow cylindrical body that has at least one and more typically two or more slots at one end that prevent solid particles and other objects from entering the dispensing tip while at the same time allowing the fluid composition to pass through. Typically, the slots are half-moon or crescent shaped openings that trap particles in the wider portion of the opening while allowing the fluid to pass around the trapped objects and into the dispensing tip. In this way, the solid particles are filtered out of the composition and retained in the storage container without blocking the dispenser tip.

The particles in the fluid composition may be of substantially uniform size or may vary in size. The filter unit may block all or only a portion of the particles in the composition.

In some implementations, the composition may contain particles that are larger than the diameter of the exit orifice and particles that are smaller than the diameter of the exit orifice. In order to prevent the larger particles from clogging the exit orifice, the width of the filter slot(s) at the widest point is typically less than the diameter of the exit orifice. Thus, only particles that are capable of passing through the exit orifice are allowed into the dispenser tip while particles that could clog the exit orifice are kept in the container.

As used herein, “a” or “an” means “at least one” or “one or more” unless otherwise indicated. In addition, the singular forms “a”, “an”, and “the” include plural referents unless the content clearly dictates otherwise. Thus, for example, reference to a composition containing “a compound” includes a mixture of two or more compounds.

As used in this specification and the appended claims, the term “or” is generally employed in its sense including “and/or” unless the content clearly dictates otherwise. In addition, the terms “comprises”, “comprising” and variations thereof do not have a limiting meaning where they appear in the description and the claims.

The recitation herein of numerical ranges by endpoints is intended to include all numbers subsumed within that range (e.g. 1 to 5 includes, 1, 1.5, 2, 2.75, 3, 3.8, 4 and 5). In addition, unless otherwise indicated, all numbers expressing quantities of ingredients, measurement of properties such as contrast ratio and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The above summary is not intended to describe each embodiment or every implementation of the invention. Other embodiments, features, and advantages of the present invention will be apparent from the following detailed description thereof, from the drawings, and from the claims.

### BRIEF DESCRIPTION OF THE DRAWINGS

FIG. 1 is a drawing of one embodiment of a dispenser tip filter assembly of the invention in which the filter is inserted into the filter housing chamber of the dispenser tip.

FIG. 2 is a drawing showing the dispenser tip filter assembly of FIG. 1. with the filter unit removed from the filter housing chamber of the dispenser.

FIG. 3a and FIG. 3b are a drawings of a cross section view of the dispenser tip shown in FIGS. 1 and 2.

FIG. 4 is a drawing of the top view of the filter housing chamber of the dispenser tip shown in FIG. 3.

FIG. 5 is a drawing of the filter unit of the dispenser tip filter assembly shown in FIGS. 1 and 2.

FIG. 6a is a drawing of a cross section view of the filter unit shown in FIG. 5.

FIG. 6b is a drawing of the side view of the filter unit shown in FIG. 5.

FIG. 6c is a drawing showing an expanded view of the base of the filter unit shown in FIG. 5.

FIG. 7 is a drawing of the top view of the filter unit shown in FIG. 5.

### DETAILED DESCRIPTION

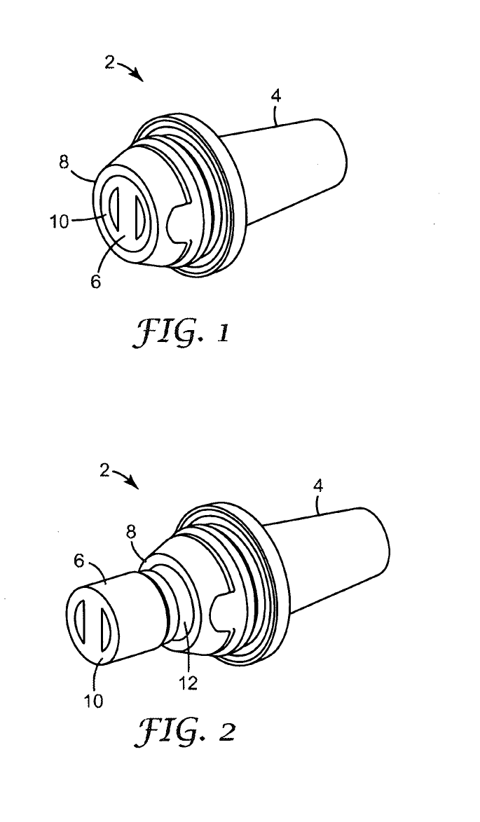

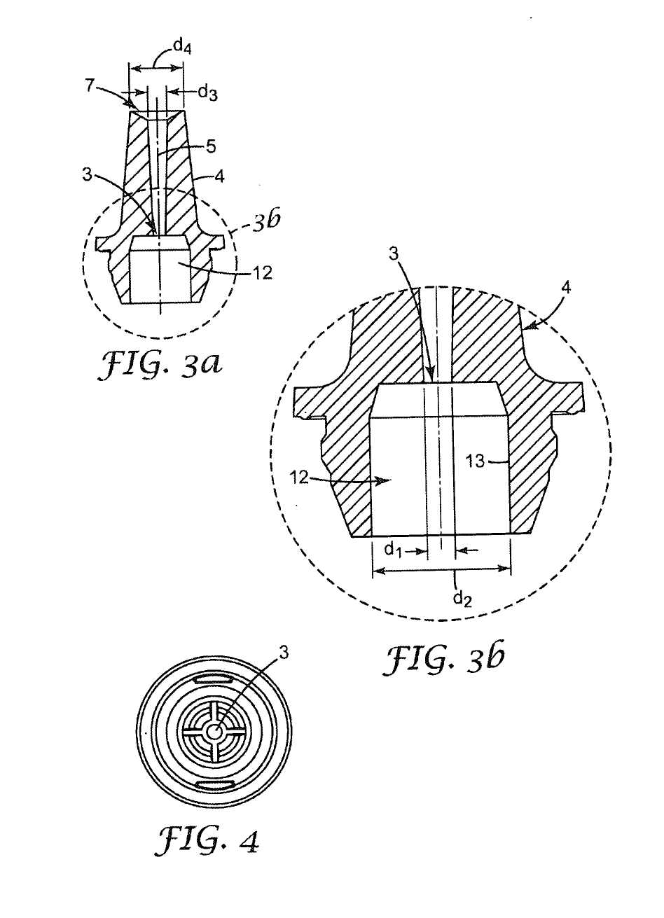

An embodiment of the invention is shown in FIGS. 1 and 2, which depict a dispenser tip filter assembly (2) that includes a dispenser tip (4) that has an exit channel (shown in FIG. 3) through which fluid is dispensed. The dispenser tip (4) also has a filter housing chamber (12) that holds a filter unit (6) that filters fluid entering the dispenser tip (4). In FIG. 1, the filter unit (6) is seated within the filter housing chamber (12) of the dispenser tip (4) such that the top surface (8) of the dispenser tip (4) is flush with the top side (10) of the filter unit (6). FIG. 2 shows the assembly (2) with the filter unit (6) removed from the filter housing chamber (12).

As shown in FIGS. 3a and 3b, the filter housing chamber (12) has an outlet (3) on one side through which fluid leaves the chamber and enters the exit channel (5) of the dispenser tip. The exit channel (5) has its smallest diameter d₁ at the beginning of the exit channel (5). The channel widens towards the distal end (7), and has its widest diameter d₄ at the opening of the distal end (7). In alternative embodiments, the diameter of the exit channel may remain substantially the same throughout the length of the dispenser tip, or may decrease towards the distal end.

As used herein, the “exit orifice” of the dispenser tip refers to the point of the exit channel with the smallest diameter, i.e. the narrowest point through which fluid passes on its way out of the dispenser tip. This may occur at any point along the length of the exit channel, i.e. at the beginning, at some point in the middle, or at the very end of the channel. In the embodiment shown in FIG. 3a, the exit orifice is found at the outlet (3) of the filter housing chamber as this is the narrowest point of the exit channel (5).

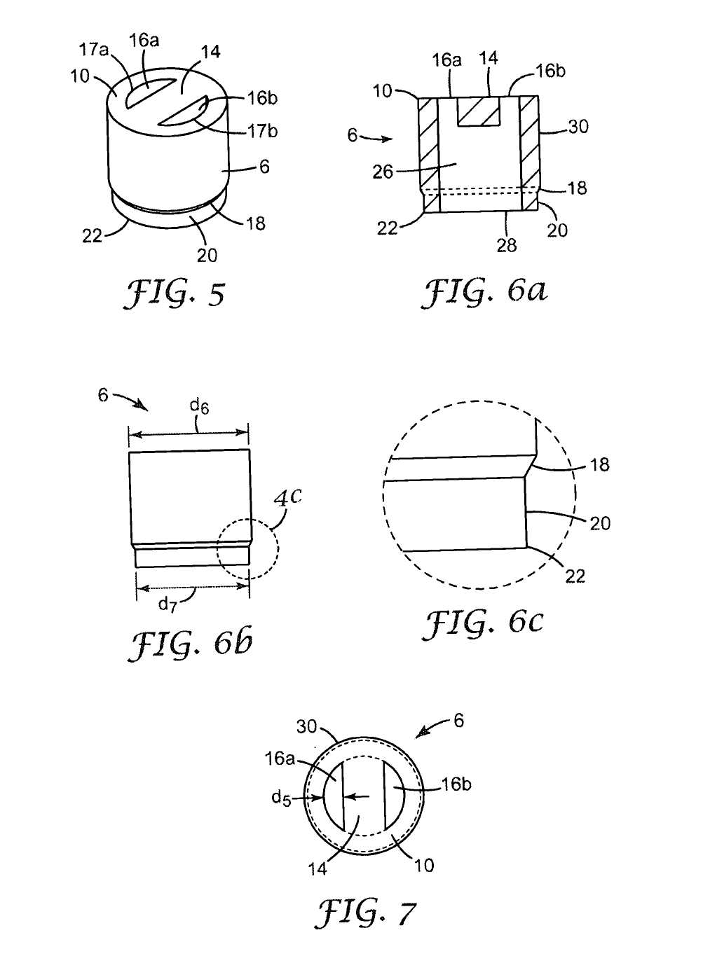

Turning now to FIGS. 5-7, the filter unit (6) of the assembly has at least one and typically two or more openings (16a, 16b) through which fluid passes to enter the dispensing tip. The openings are typically small enough to block passage of solid particles and objects present in the fluid composition that might clog the dispenser tip or otherwise interfere with the flow of fluid out of the exit orifice. Typically, the openings are in the form of slits or slots having a width no greater than the diameter of the exit orifice. In addition, the width of the slot(s) is typically varied so that a portion of the slot(s) has a narrower width than another portion of the slot.

The body of the filter typically has a shape that is complementary to the contours of the filter housing chamber of the dispenser tip so that the filter unit fits within the filter housing chamber. Most typically, the body of the filter has a hollow, cylindrical shape, but any suitable shape may be used.

In the embodiment shown in FIG. 5, the filter unit (6) has an elongated, cylindrical body with a top side (10), a bottom side (22), and a hollow center (26). The top side (10) has a flat surface with two slots (16a, 16b) that restrict the movement of solid particles within the fluid. The bottom side (22) has an opening (28) through which fluid passes on its way to the exit channel of the dispenser tip.

The filter slots (16a, 16b) typically have one or more arcuate or arc-shaped sides (17a, 17b) that give the slot a crescent or half-moon shape. Such slots may be formed, for example, by positioning a rectangular divider (14) across the circular opening at the top side of (10) the hollow cylindrical body. This generally increases the surface area for the fluid to flow through while at the same time blocking all or substantially all particles with a diameter equal to or greater than the diameter d₅ (sec FIG. 7) of the widest portion of the slot. In alternative implementations of the invention, the slots or openings may have other shapes, such as, for example, a diamond, oval, triangle, rectangle, or circle.

In one implementation, the widest portion of each filter slot (16a, 16b) is narrower than the diameter d₁ of the exit orifice of the dispenser tip. This prevents particles that are large enough to block the exit orifice from entering the dispenser tip thus promoting smooth flow of the fluid out of the device.

The filter unit (6) may be secured within the filter housing chamber (12) by means of an interference fit, e.g. by providing the filter unit (6) with a diameter d₆ (see FIG. 6b) that is slightly larger than the diameter d₂(see FIG. 6) of the filter housing chamber (12) so that when seated in the filter housing chamber (12) the outer wall (30) of the filter unit (6) presses against the side wall (13) of the filter housing chamber (12) with sufficient force to hold the filter unit (6) in place. This can be accomplished, for example, by providing a filter unit (6) made of a slightly compressible material, such as low-density polyethylene or a similar polymeric material. Alternatively, other means may be used to secure the filter unit into the filter housing chamber, including but not limited to, adhesives, locking mechanisms, melt-bonding, and the like. It is also possible that the filter unit could be formed as an integral portion of the dispenser tip.

For easy insertion of the filter unit (6) into the filter housing chamber (12), the lower portion (20) of the filter unit proximate to the bottom side (22) may optionally be provided with a diameter d₇ that is less than the diameter d₆ of the upper portion of the filter unit, as shown in FIGS. 6a and 6b. This configuration is particularly useful when the filter unit (6) is secured by means of an interference fit because it allows the filter unit (6) to be easily positioned within the opening of the filter housing chamber (12) prior to being forced into place within the chamber. To further facilitate the placement of the filter unit (6) into the filter housing chamber (12), the filter unit (6) may also have a chamfer (18) or similar beveled surface between the portions of the body having different diameters.

The dispenser tip assembly of the invention may be configured to fit onto any type of container used for storing chemical compositions. For example, the dispenser tip may be fitted onto a vial, bottle, flask, syringe, or similar vessel. In one embodiment, the assembly is releasably attached to the container by means of a screw on or snap on mechanism. This is particularly convenient when the composition is stored, for example, in a vial having a cap or similar means for sealing the contents. The cap can be removed and the dispenser tip assembly screwed onto the vial for dispensing the composition. When dispensing is completed, the dispenser cap may then be removed and the cap placed back on the container. Alternatively, if it is desirable for the dispenser tip assembly to remain on the container during storage, the assembly may be provided with a cap that fits over the exit orifice to seal the container. In such implementations, the user need only remove the cap from the dispenser tip assembly and the composition is ready to be dispensed.

The components of the filter dispenser tip assembly may be made of any of variety of materials. Most typically the assembly is made of a plastic or similar polymeric material, such as low-density polyethylene, that is non-reactive with the composition stored in the container. The various components may be made from the same material or from different materials, using well-known techniques, such as, for example, injection molding.

Various modifications and alterations to the invention will become apparent to those skilled in the art without departing from the scope and spirit of this invention. It should be understood that the invention is not intended to be unduly limited by the specific embodiments and examples set forth herein, and that such embodiments and examples are presented merely to illustrate the invention, with the scope of the invention intended to be limited only by the claims attached hereto.

The complete disclosures of the patents, patent documents, and publications cited herein are hereby incorporated by reference in their entirety as if each were individually incorporated.

1. A dispenser tip filter assembly comprising:
a dispenser tip comprising a filter housing chamber and an exit orifice, and
a filter unit positioned within the filter housing chamber in front of the exit orifice,
wherein the filter unit comprises at least one slot having a width that is less than the diameter of the exit orifice.

2. The dispenser tip filter assembly of claim 1, wherein one portion of the slot is wider than another portion of the slot.

3. The dispenser tip filter assembly of claim 1, wherein the slot has at least one arcuate side.

4. The dispenser tip assembly of claim 1, wherein the filter unit has a hollow cylindrical body having a top side and a bottom side.

5. The dispenser tip assembly of claim 4, wherein the slot is positioned on the top side of the cylindrical body.

6. The dispenser tip assembly of claim 4, wherein the cylindrical body has a diameter at the bottom of the cylindrical body that is smaller than the diameter of another portion of the cylindrical body.

7. A method for dispensing in a fluid dental composition containing solid particles from a container, the method comprising the steps of:
providing a fluid dental composition that contains solid particles,
passing the fluid dental composition through a filter having at least one slot that is shaped so as to prevent passage of the solid particles and allow passage of the fluid dental composition.

8. The method of claim 7, wherein the composition is a dental restorative.

9. The method of claim 8, wherein the composition is a dental adhesive.

10. The method of claim 7, wherein the solid particles comprise a water scavenger.

11. The method of claim 10, wherein the water scavenger comprises a molecular sieve.
